(19) United States
(12) Patent Application Publication
(10) Pub. No.: US 2009/0295735 A1
(43) Pub. Date: Dec. 3, 2009

(54) Electronic Device and Method for Automatically Converting Text into a Speech Signal

(75) Inventors: Wang Wang, Nanjing (CN); Wei Guo, Nanjing (CN); Kan Ni, Nanjing (CN); Danilo Tan, Pembroke Pines, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/127,333

(22) Filed: May 27, 2008

(51) Int. Cl. G06F 3/02; G10L 13/00

(52) U.S. Cl. 345/169; 704/260; 704/270; 704/E13.011

(57) ABSTRACT

An electronic device and a method for automatically converting text to be displayed on a display screen of an electronic device into a speech signal when ambient light conditions affect viewing of the text. The method is performed by the electronic device and the method includes receiving a command to display text on the display screen and determining if an ambient light signal provided by an ambient light sensor is above a pre-determined viewing threshold. This ambient light signal corresponds to ambient light conditions adjacent the display screen. The method also includes automatically converting the text to a speech signal when the ambient light signal is above the pre-determined viewing threshold. Suitably, there is performed a step of emitting the speech signal in an audible form from a speaker.

### FIELD OF THE INVENTION

The present invention relates generally to an electronic device and a method for automatically converting text to be displayed on a display screen of the electronic device into a speech signal. More specifically, the invention provides for automatically converting the text into a speech signal when ambient light conditions affect viewing of the text on the display screen.

### BACKGROUND OF THE INVENTION

Electronic display screens for presenting and displaying information, such as text messages, exist in several known electronic devices that include laptop computers, calculators, watches, two way radios and cellular telephones. Conventionally, display screens are usually a liquid crystal display (LCD) that may be selectively programmed to display the information. Typically, the display screen includes a reflective element contiguous to the display screen for reflecting light or a backlight assembly for providing light through the display to improve the readability of the information or even a combination of both a reflective element and a backlighting assembly. Still some known electronic devices that have display screens have included a light sensor for enabling or adjusting the brightness of the backlight assembly for varying ambient light conditions.

In very bright ambient light conditions, such as when direct sunlight radiates onto the display screen, it is very difficult, if not impossible, to read text displayed on display screen even if the backlight assembly is at maximum brightness. Also, in such very bright ambient light conditions it may be painful on a user's eyes when attempting to read to read text displayed on display screen.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating schematic diagram of an electronic device typically in the form of a mobile telephone according to some embodiments of the present invention; and

FIG. 2 is a flow diagram illustrating a method for automatically converting text to be displayed on the display screen of the electronic device of FIG. 1 into a speech signal when ambient light conditions affect viewing of the text, the method being in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in device components related to an electronic device and method. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that device components and method steps that comprises a list of elements does not include only those elements but may include other elements not expressly listed or inherent to such device components or method steps. An element proceeded by “comprises . . . a” does not, without more constraints, preclude the existence of additional identical elements in the method, or device that comprises the element.

According to one aspect of the present invention, there is provided an electronic device comprising a processor including a text to speech module and a display screen coupled to the processor. The electronic device also has an ambient light sensor coupled to the processor. The ambient light sensor provides an ambient light signal corresponding to ambient blight conditions adjacent the display screen. When the ambient light signal is above a pre-determined viewing threshold and the processor receives a command to display text on the display screen, the text to speech module automatically performs converting the text to a speech signal. Suitably, the speech signal is emitted in an audible form from an speaker

According to another aspect of the present invention, there is provided a method for automatically converting text to be displayed on a display screen of an electronic device into a speech signal when ambient light conditions affect viewing of the text. The method is performed by the electronic device and the method includes receiving a command to display text on the display screen and determining if an ambient light signal provided by an ambient light sensor is above a pre-determined viewing threshold. This ambient light signal corresponds to ambient light conditions adjacent the display screen. The method also includes automatically converting the text to a speech signal when the ambient light signal is above the pre-determined viewing threshold. Suitably, there is performed a step of emitting the speech signal in an audible form from a speaker.

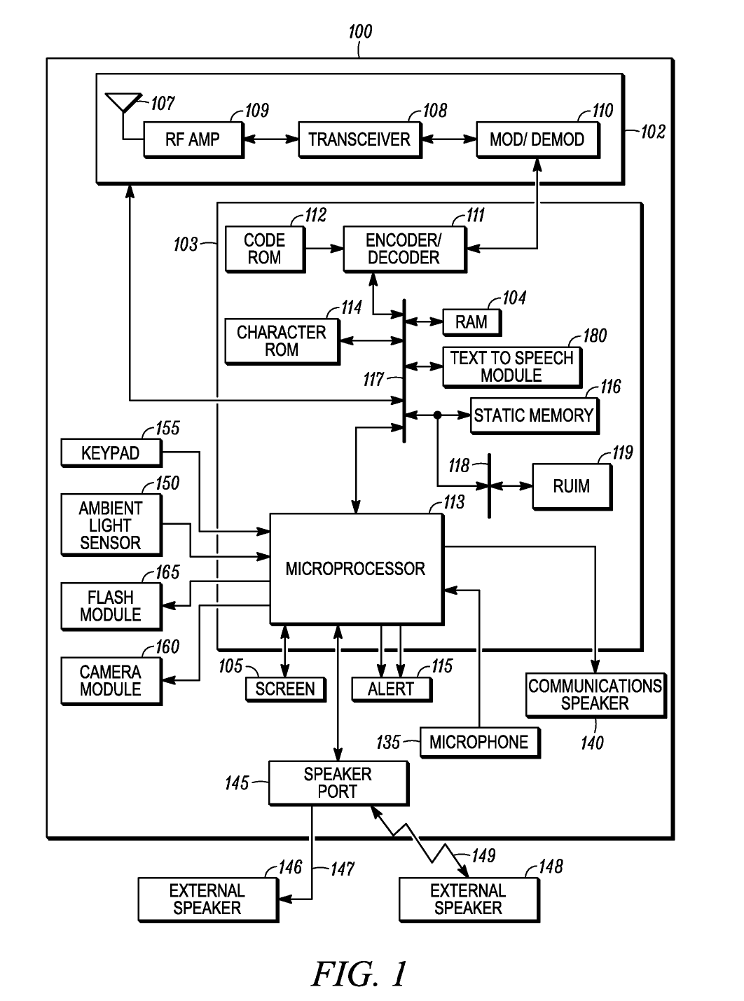

Referring to FIG. 1, there is illustrated a schematic diagram of an electronic device 100, typically a communications device in the form of a mobile telephone comprising a radio frequency communications unit 102 coupled to be in communication with a processor 103. The electronic device 100 includes a display screen 105 that includes a backlighting assembly for illuminating, pictures, text or indicia displayed on the display screen 105. There is also an alert module 115 that typically contains an alert speaker, vibrator motor and associated drivers. The display screen 105, and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, the radio frequency communications unit 102, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static programmable memory 116 may also store passwords for allowing accessibility to password-protected functions. The processor 103 also includes a text to speech module 180 that is coupled by the common data and address bus 117 to the micro-processor 113. The text to speech module 180 is a conventional text to speech module that includes a lexicon and code for converting text to a speech signal as will be apparent to a person skilled in the art.

The micro-processor 113 has ports for coupling to the display screen 105, and the alert module 115. Also, micro-processor 113 has ports for coupling to a microphone 135, an ambient light sensor 150, a camera module 160, a flash module 165, a communications speaker 140 that is integral with the electronic device 100, a speaker port 145 and keypad 155. The speaker port 145 provides for either an external speaker 146 to be selectively coupled by a wired link 147 to the processor 103 or an external speaker 148 to be selectively coupled by a wireless link 149 to the processor. The external speakers 146, 148 are usually in an earpiece forming part of part of a headset that can be selectively coupled to the electronic device 100. If either the external speaker 146 or the external speaker 148 is coupled to the processor 103 then usually the communications speaker 140 is inoperative as will be apparent to a person skilled in the art.

The character Read Only Memory 114 stores code for decoding or encoding text messages that may be received by the radio frequency communications unit 102 and an ambient light sensor 150 can be used for automatically invoking the flash module 165 during operation of the camera module 160. The ambient light sensor 150 is also used for providing an ambient light signal corresponding to ambient blight conditions adjacent the display screen 105 as will be described later.

Typically the radio frequency communications unit 102 is a combined receiver and transmitter having an antenna 107. The radio frequency communications unit 102 has a transceiver 108 coupled to the antenna 107 via a radio frequency amplifier 109. The transceiver 108 is also coupled to a combined modulator/demodulator 110 that couples the radio frequency communications unit 102 to the processor 103. Also, in this embodiment the character Read Only Memory 114, RUIM card 119 and static programmable memory 116 may also store Operating Code (OC) for the micro-processor 113 and code for performing standard functions associated with the electronic device 100.

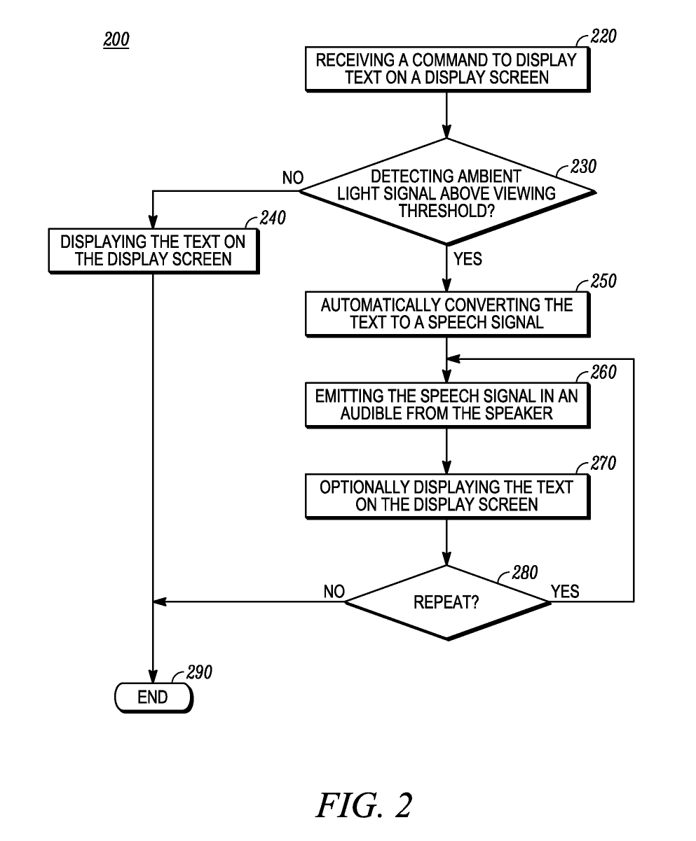

Referring to FIG. 2 there is illustrated a method 200 for automatically converting text to be displayed on the display screen 105 of the electronic device 100 into a speech signal when ambient light conditions affect viewing of the text. The method 200 is invoked, at a receiving a command block 220, in response to the processor 103 of the electronic device 100 receiving a command to display text on the display screen 105. The receiving of the command is typically provided automatically upon the electronic device (which in this embodiment is a communications device) receiving a text message via the radio frequency communications unit 102. In an alternative embodiment, the receiving of the command is provided by actuation of a key on the keypad 155 of the electronic device 100. The actuation of the key performs the command operation of requesting text such as a text file or otherwise to be displayed on the display screen 105. No matter how the receiving of the command is generated, it will be apparent to a person skilled in the art that the text to be displayed is typically in a text file or in a text message such as an email message, a Short Message Service (SMS) message, a Multimedia Message Service (MMS) message or an Enhanced Message Service (EMS) message.

After the method 200 is invoked at the receiving the command block 220 a determining test is performed at a determining block 230. The determining test performs at test for determining if an ambient light signal provided by the ambient light sensor 150 is above a pre-determined viewing threshold. In this regard, the ambient light signal corresponds to ambient blight conditions adjacent the display screen 105. Thus, it will be apparent to a person skilled in the art that the ambient light sensor 150 is located on the electronic device 100 in a position near the display screen 105 so that the light radiating onto the ambient light sensor 150 is of a similar luminous intensity to the light radiating onto the display screen 105. It should be noted that the ambient light sensor 150 is also the same ambient light sensor 150 used by the camera module 160 when determining if the flash module 165 is required when taking pictures or videos. However, it is envisaged that there may be a separate ambient light sensor for the camera module 160.

If at the determining block 230 it is determined that the ambient light signal is below the pre-determined viewing threshold then the method 200 performs displaying the text on the display screen 105 at a displaying block 240 and then the method 200 terminates at an end block 290. Alternatively, if at the determining block 230 it is determined that the ambient light signal is above the pre-determined viewing threshold then the method 200 performs automatically converting the text to a speech signal at an automatically converting block 250. The converting of the text to a speech signal is performed by the text to speech module 180 that is controlled by the microprocessor 113.

After the automatically converting block 250 performs converting the text to a speech signal when the ambient light signal is above the pre-determined viewing threshold, the method 200 then performs, at an emitting block 260, a subsequent step of emitting the speech signal in an audible form from a speaker. This speaker can be the communications speaker 140 that is integral with the electronic device 100 or one of the external speakers 146, 148. The text may be optionally displayed on the display screen 105 as shown in an optionally displaying block 270. Next a test block 280 determines if the processor 103 is in receipt of a repeat command provided by actuation by an input key of the keypad 155 on the electronic device 100. If at test block 280 it is determined that no repeat command has been entered actuation by an input key of the keypad 155 the method 200 terminates at the end block 290.

If at test block 280 it is determined that the processor 103 is in receipt of the repeat command, then this results in the subsequent step of emitting is repeated at the emitting block 260. Hence, the speech signal is again emitted in the audible form in case a user needs to re-listen to the emitted speech signal. This feature can be useful, for instance, when the text that is converted to the speech signal is relatively long or difficult to understand from a single hearing. The method can also be configured so that during the step of emitting the speech signal, a pause feature can halt the emitted signal and the user can replay part or all of the previously emitted signal. This is best achieved by the speech signal being stored in the RAM 104 during the automatically converting block 250 and thus there is no need to repeat text to speech conversion by the automatically converting block 250, the same also applies to when the emitting block 260 is repeated in response to the repeat command determined at test block 280.

Suitably, during the automatically converting the text to a speech signal performed by the automatically converting block 250 and the step of emitting at the emitting block 260, the backlighting assembly of the display screen 105 is switched off. Thus, the backlighting assembly is switched off when the ambient light signal is above the pre-determined viewing threshold thereby battery power drain can be reduced thereby prolonging battery charge (assuming the electronic device 100 is battery powered).

It is envisaged that different users of the electronic device 100 will have varying degrees of eyesight and brightness comfort viewing levels. Accordingly, the pre-determined viewing threshold can be set by the user.

Advantageously, the present invention provides for automatically converting the text to a speech signal when the ambient light signal is above the pre-determined viewing threshold and emitting the speech signal in an audible form. Thus, in very bright ambient light conditions, such as when direct sunlight radiates onto the display screen 105, the present invention provides automatically a speech simulated version of text contained in a message or text file that was intended to be displayed on the display screen.

It will be appreciated that the embodiment of the present invention described herein may be comprised of one or more conventional processors and unique stored program instructions that control the one or more processors to implement, in conjunction with certain non-processor circuits, some, most, or all of the functions for the electronic device as described herein. The non-processor circuits may include, but are not limited to, a radio receiver, a radio transmitter, signal drivers, clock circuits, power source circuits, and user input devices. As such, these functions may be interpreted as steps of the method 200 to perform automatically converting text to be displayed on a display screen of an electronic device into a speech signal. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. An electronic device comprising:
A processor including a text to speech module;
A display screen coupled to the processor; and
An ambient light sensor coupled to the processor, the ambient light sensor providing an ambient light signal corresponding to ambient blight conditions adjacent the display screen, wherein when the ambient light signal is above a pre-determined viewing threshold and the processor receives a command to display text on the display screen, the text to speech module automatically performs converting the text to a speech signal.

2. An electronic device as claimed in claim 1, wherein the speech signal is emitted in an audible form from a communications speaker coupled to the processor, the communications speaker being integral with the electronic device.

3. An electronic device as claimed in claim 1, wherein the speech signal is emitted in an audible form from an external speaker selectively coupled to the processor.

4. An electronic device as claimed in claim 1, wherein the display screen includes a backlighting assembly that is switched off when the ambient light signal is above the pre-determined viewing threshold.

5. An electronic device as claimed in claim 1, wherein the pre-determined viewing threshold is set by a user of the device.

6. An electronic device as claimed in claim 2, further including a keypad coupled to the processor, wherein actuation of a key of the keypad provides a repeat command that results in the speech signal being again emitted in the audible form from the communications speaker.

7. An electronic device as claimed in claim 3, further including a keypad coupled to the processor, wherein actuation of a key of the keypad provides a repeat command that results in the speech signal being emitted in the audible form from the external speaker.

8. A method for automatically converting text to be displayed on a display screen of an electronic device into a speech signal when ambient light conditions affect viewing of the text, the method being performed by the electronic device, the method comprising:
Receiving a command to display text on the display screen;
Determining if an ambient light signal provided by an ambient light sensor is above a pre-determined viewing threshold, the ambient light signal corresponding to ambient light conditions adjacent the display screen; and
Automatically converting the text to a speech signal when the ambient light signal is above the pre-determined viewing threshold.

9. A method for automatically converting text as claimed in claim 8, wherein the device is a communications device and the receiving a command is provided automatically upon the communications device receiving a text message.

10. A method for automatically converting text as claimed in claim 8, wherein the device is a communications device and the receiving a command is provided by actuation of a key on a keypad of the device.

11. A method for automatically converting text as claimed in claim 8 further comprising a subsequent step of emitting the speech signal in an audible form from a speaker that is integral with the electronic device.

12. A method for automatically converting text as claimed in claim 8 further comprising a subsequent step of emitting the speech signal in an audible form from an external speaker.

13. A method for automatically converting text as claimed in claim 8, wherein the display screen includes a backlighting assembly that is switched off when the ambient light signal is above the pre-determined viewing threshold.

14. A method for automatically converting text as claimed in claim 8, wherein the pre-determined viewing threshold is set by a user of the device.

15. A method for automatically converting text as claimed in claim 11, wherein upon receipt of a repeat command provided by actuation by an input key of the electronic device, the subsequent step of emitting is repeated.

16. A method for automatically converting text as claimed in claim 11, wherein upon receipt of a repeat command provided by actuation of an input key of the electronic device, the subsequent step of emitting is repeated.
